(19) United States
(12) Patent Application Publication
(10) Pub. No.: US 2012/0242251 A1
(43) Pub. Date: Sep. 27, 2012

(54) AMBIENCE LIGHTING SYSTEM USING GLOBAL CONTENT CHARACTERISTICS

(75) Inventors: Cornelis Wilhelmus Kwisthout, Eindhoven (NL); Etienne Rene Eveline Coezijn, Eindhoven (NL); Maria Helena Schut, Eindhoven (NL)

(73) Assignee: KONINKLIJKE PHILIPS ELECTRONICS N.V., EINDHOVEN (NL)

(21) Appl. No.: 13/498,724

(22) PCT Filed: Nov. 18, 2010
(86) PCT No.: PCT/IB10/55258

§ 371 Date: Mar. 28, 2012

(30) Foreign Application Priority Data
Dec. 18, 2009 (EP) 09179913.0

(51) Int. Cl. H05B 37/02; F21V 14/00

(52) U.S. Cl. 315/297; 362/231

(57) ABSTRACT

The invention relates to an ambience lighting system, typically for use in conjunction with a display device. The ambience lighting system may be of the type AmbiLight. The ambience lighting system comprises one or more light sources associated to subregions of the display screen; a content characterizer for determining content characteristics of image data of the sub-regions; and a controller to control the color of the emitted ambience light in accordance with determined content characteristics. The content characterizer is further adapted to determine content characteristics of a global region of the display screen, and the controller is adapted to control the color of the emitted ambience light in accordance with the determined content characteristics of the subregions and of the global region.

### FIELD OF THE INVENTION

The invention relates to an ambience lighting system and in particular to an ambience lighting system visual suitable for use in conjunction with a display device.

### BACKGROUND OF THE INVENTION

A number of different types of display devices are known and available to the user, such as television sets based on various technologies. The display devices are normally employed to present images or image sequences to a viewer. In the 1960s, backlighting was introduced due to the fact that televisions required a “darker” room for optimal viewing. Backlighting is in its simplest form white light, emitted from e.g. a light bulb, projected on a surface behind the visual display device. Backlighting has been suggested to be used to relax the iris and reduce eye strain. During recent years the backlighting technology has become more sophisticated and there are several display devices on the market with integrated backlighting features that enables emitting colors with different brightness depending on the visual information presented on the display device. The benefits of backlighting in general includes: a deeper and more immersive viewing experience, improved color, contrast and detail for best picture quality, and reduced eye strain for more relaxed viewing. One example of a commercial available display device with backlighting is the ambience lightning system Ambilight™ as sold by Philips.

A typical Ambilight™ system comprises peripherally arranged light sources for emitting light that appear to the user to illuminate a region surrounding the TV-screen. The known Ambilight™ system extrapolate the edges of the screen content by controlling the color of the light sources to mimic the color of the edge region to which the individual light sources abut. The light sources are controlled to mimic such content characteristics as brightness and saturation of the edge regions on the screen.

### SUMMARY OF THE INVENTION

The inventors of the present invention have realized that an ambience lightning system may in some situation be perceived to distract the viewer from the content presented on the display screen. The inventors have moreover realized that such situations may occur when there is a discrepancy between the content characteristic of the content positioned near the edge and the overall impression of this content characteristic. To this end, it would be advantageous to achieve an ambience lightning system which provides an even deeper and more immersive viewing experience than available in current systems. Moreover, it would also be desirable to provide an ambience system which enables the user to apply individual settings on the ambience lighting system. In general, the invention preferably seeks to mitigate, alleviate or eliminate one or more of the above mentioned disadvantages, or other disadvantages of the prior art, singly or in any combination.

To better address one or more of these concerns, in a first aspect of the invention an ambience lighting system for use in conjunction with a display device is presented that comprises a display screen, and

one or more light sources adapted for emitting an ambience light, the one or more light sources being disposed in a configuration so that light emitted therefrom illuminates an illumination region visually appearing to a viewer, the one or more light sources each being associated to subregions of the display screen;

a content characterizer adapted for determining content characteristics of image data of the subregions of the display screen;

a controller adapted to control the color of the emitted ambience light of the one or more light sources in accordance with determined content characteristics; wherein the content characterizer is further adapted to determine content characteristics of a global region of the display screen, and wherein the controller is adapted to control the color of the emitted ambience light of the one or more light sources in accordance with the determined content characteristics of image data of the subregions and of the global region.

By determining the content characteristic of image data of subregions and of the global region it is rendered possible to modulate local color settings by global content characteristics to obtain a system where localized illumination is integrated in the overall illumination of the entire device. For example, if very bright content displayed near the edge of the display screen in an overall dark scene results in a bright coloring of the ambience lighting in the same region, this may be perceived as distracting by many users. Instead by dimming the ambience lighting in this region not to emphasize the bright part of the scene too much, the viewing experience may be perceived to be more relaxed.

In advantageous embodiments, the ambience lighting system is of the type where the light sources are positioned at the periphery of the display device or the rear side of the display device, where the illumination region visually appearing to the viewer to at least partly surround the display screen. In embodiments, the light sources may emit light onto a wall or screen behind the display device to provide a back-lighting system or emit light outward towards the viewer to provide an ergo lighting system. In other embodiments, however, the ambience lighting system may be positioned separate from the display device. The term ambience lighting should in the context of the present invention be construed broadly, and in general to include any systems which are capable of based on an input signal to emit dynamic light to influence the general lighting of a room or other environment. The control of the light sources may be done in a number of ways and is generally known to the skilled person. In an example, the controller, receives inputs related to such characteristics as intensity and color, which is converted into operational settings such as power settings on the individual sources.

In general, the display screen may be divided into subregions, segments or areas from which local content characteristics are extracted. In advantageous embodiments the subregions are regions in the edge region of the display screen where a light source is associated to a subregion to which it abuts. In such embodiments, the ambience systems may thus extrapolate content characteristics displayed at the edge region of the display devices beyond the edge itself. In general, however, the subregion may be associated to other regions of the display screen, and in principle to any subregion of the display screen. In addition to the subregion, also a global region may be defined from which global content characteristics can be extracted. The global region may in embodiments be the entire display screen or substantial parts of the display screen. The shape or form of the subregion or global region are not confined to any particular shape or form, in particular the regions need not to be confined to a single coherent region but may be formed by separate or abutting areas.

In advantageous embodiments the content characteristics are selected from the group consisting of: a brightness measure, a contrast measure, saturation measure, a measure related to the dynamics of content displayed on the display screen or a measure of 3D depth of the content displayed on the display screen, audio content accompanying content displayed on the display screen, or a combination of one or more thereof. The graphic processor of a modern TV-set may generate a number of content characteristic measures for a number of reasons. In embodiments may such content characteristic measures which are generated for other purposes be used in connection with controlling the emitted ambience light. In general, however, any suitable content characteristic may be used.

In an advantageous embodiment, the system further comprises an input unit adapted for receiving input commands from a user; and where the controller is further adapted to control the color of the emitted ambience light of the one or more light sources in accordance with the received input commands. It is an advantage of embodiments of the present invention that the invention on one hand enables device control of the emitted ambience light, but nevertheless, on the other hand, supports user preferences. Embodiments which support specific user-preferences may thereby be provided.

In a second aspect of the invention a controller for controlling the color of emitted ambience light of an ambience lighting system to which the controller is operatively connected is presented. The controller comprises or is communicatively connected to a content characterizer adapted for determining content characteristics of subregions and a global region of a display screen associated to the ambience lighting system; wherein the controller is adapted to control the color of the emitted ambience light of the one or more light sources in accordance with the determined content characteristics of the subregions and of the global region. The controller is thereby rendered with the functionality suitable for operating the light sources of the ambience lighting system of the first aspect.

In a third aspect of the invention a display device comprising an ambience light system according to the first aspect is presented. Such a display device may be in the form of an LCD device, a plasma device, an organic light-emitting diode (OLED) device or projection screen.

In a forth aspect of the invention a method of operating an ambience lighting system used in conjunction with a display device is presented. The device includes a display screen. The ambience lighting system may be a system in accordance with the first aspect of the invention,

the method comprising:

associate each of the one or more light sources to subregions of the display screen;

determining content characteristics of the subregions of the display screen;

determine content characteristics of a global region of the display screen;

control the color of the emitted ambience light of the one or more light sources in accordance with the determined content characteristics of the subregions and of the global region.

In a forth aspect of the invention, a computer program product is presented, which when running on a computing device, may be implemented to perform the method steps of the third aspect of the invention.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates an embodiment of a display device 1 in the form of a TV equipped with an ambience lighting system;

FIGS. 2A and 2B show schematic and simplified illustrations of embodiments of the present invention;

FIG. 3 schematically shows an example of a transfer function, which maps the global saturation;

FIG. 4 is a schematic illustration the operation of an ambience lighting system in accordance with an embodiment of the present invention; and

FIG. 5 schematically illustrates an embodiment of general steps in the operation of an ambience lighting system in accordance with the present invention.

### DESCRIPTION OF EMBODIMENTS

FIG. 1 illustrates an embodiment of a display device 1 in the form of a TV equipped with an ambience lighting system in accordance with embodiments of the present invention. As an example the display device may be a flat-screen TV with Ambilight™ backlighting, as sold by Philips. In the following, the focus is on embodiments of a display device in the form of a TV-set with an at least partly peripheral backlighting system, however the invention is not limited to such a system, instead embodiments of the invention may be used in any type of visual display system employing ambience lighting. An example of an alternative or additional ambience lighting system is a separate illumination source, such as a lamp having a lamp driver which is communicatively connected to a TV-screen, such that the illumination or light emitted by this separate source varies in accordance with content characteristics of the subregions of the display screen. In this situation, an average content characteristic of the subregions may be used to drive the separate illumination source, or a dedicated or group of subregions may be associated to the separate illumination source.

FIG. 1 illustrates an ambience lighting system that is used in conjunction with a display device having a display screen 3, i.e. the TV-screen. The system comprises one or more light sources 4-7 adapted for emitting ambience light. The light sources are disposed in a configuration so that light emitted therefrom illuminates an illumination region 8 visually appearing to the viewer. In the shown embodiment, four light sources are present, a top light source 5, a bottom light source 7 and two side light sources, i.e. a right light source 4 and a left light source 6. Other configurations of the light sources include, but are not limited to, three light sources with a top and the side light sources 4-6, and two light sources being the side light sources 4, 6. The illumination region 8 may be a wall or screen behind the TV-set. In embodiments, the light source may also be comprised or connected to the frame of the TV so that the frame forms part of, or is, the illumination region. In the illustrated embodiment, the light sources are illustrated as four individual light sources. Each light source may however be based on a number of individually controlled units, or each of the illustrated light sources may be understood as a simplified representation of a collection of individually controlled units.

The ambience lighting system comprises a controller 9 for controlling the light sources. Moreover, a data processor 10 may be present, for general data handling of the system. The controller and the data processor unit and possible other units may be part the electronic elements 11 of the TV-set. Such elements are typically placed in the housing of the TV-set, behind the TV-screen or image display region 3. Here the elements are displayed separate from the TV for illustrative reasons. The ambience lighting system may further comprising an input unit 18 adapted for receiving input commands 2 from a user. Such input commands may be related to preference settings of the user. Moreover, the ambience lighting system may comprise a content characterizer 12 adapted for determining content characteristics of subregions 13, 14 of the display screen. These subregions may each be associated to light sources, or sections of light sources 15-17, in the sense that the light emitted from a light source is based on content characteristics from a subregion to which it is associated.

The electronic elements 11 are illustrated in terms of functional units In general the electronic elements may be implemented as an integrated circuit comprising programmable parts as well as specific non-programmable electronic components where the programmable parts, such as the data processor 10, may be shared between different functional units. For example part of the data processor may be implemented as the content characterizer which again may be comprised in or communicatively connected to the controller 9. In general, the functionality of the controller and the content characterizer, as well as other components, may be implemented by a computer program product which is run by the data processor 10. The data processor 10 may e.g. be provided with the functionality of receiving a computer program product 19, such as computer code, in any appropriate form.

The light sources 4-7 may in different embodiments be different types of sources. The light sources may e.g. be cold cathode fluorescence lamps (CCFL) or light emitting diodes (LED), but are not limited to such light sources. For light sources of the CCFL type, the control unit would comprise a lamp driver including a lamp inverter for operating the CCFL sources, whereas for light sources comprising LEDs, the control unit would comprise a lamp driver for operating the LED sources.

In the shown example, the color of the light source element 15 may be based on content characteristic from the subsection 14 to which it is associated, and the color of the light source elements 16 and 17 may be based on content characteristic from the subsection 13 to which they are associated. In general may the entire edge of the display screen be divided into a number of subregions distributed along the four edges.

In embodiments, the content characterizer 12 is generally implemented to determine content characteristics of all subregions of the display screen as well as of a global region of the display screen. Based on the determined content characteristics, the controller control the color of the emitted ambience light of the sources in accordance with the determined content characteristics of the image data of the subregions and of the global region.

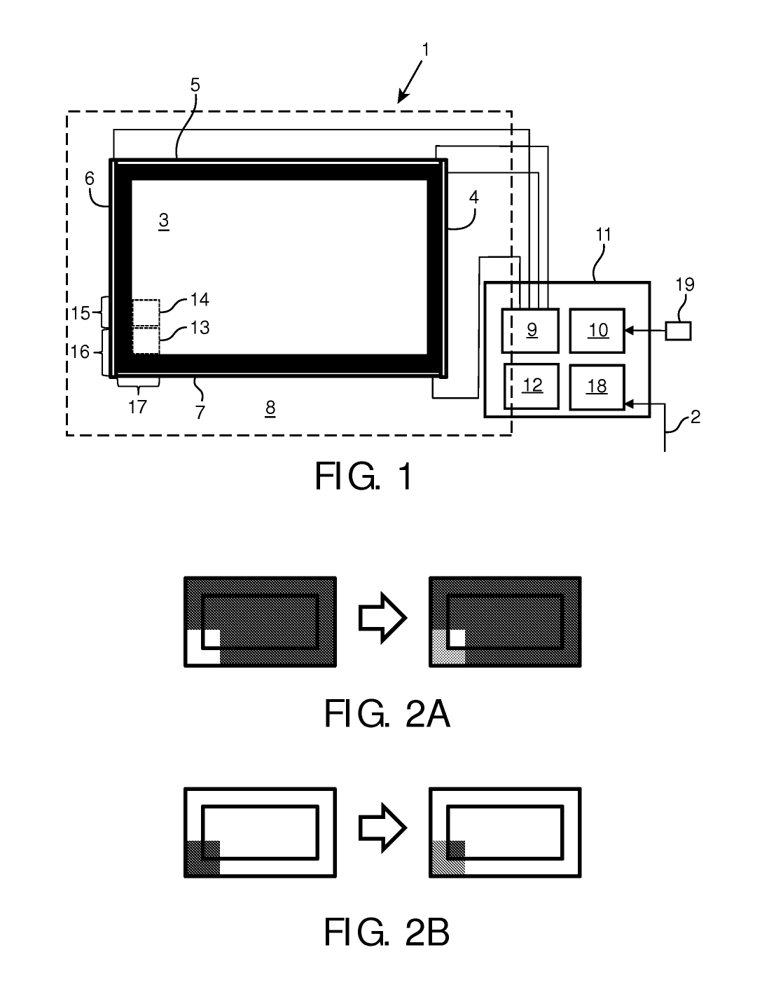

FIGS. 2A and 2B show schematic and simplified illustrations of embodiments of the present invention. The left side of FIG. 2A shows a situation where a very bright area near the edge in an otherwise dark screen is extrapolated by the ambience lighting system by extrapolating the full brightness. Whereas, the left side of FIG. 2B illustrates the inverse situation of a dark area in an otherwise bright screen. This corresponds to the situation found in known ambience systems. Embodiments of the present invention take into account the global brightness of the screen to modulate the color setting of the light sources with the overall brightness. This is illustrated in FIGS. 2A and 2B on the right side, so that the full brightness is not extrapolated by the ambience lighting system, instead the lighting is dimmed in the situation of FIG. 2A and the lighting is increased in the situation of FIG. 2B.

In FIG. 2 the content characteristic is in the form of brightness, however other content characteristics may be used. In a general embodiment, the controller controls the color of the emitted ambience light of the one or more light sources based on a mathematical function which maps the determined content characteristics of the subregions and of the global region to an output content characteristic for each of the one or more light sources. The output content characteristic is converted to the relevant control settings of the light sources. Important examples of content characteristics comprise in addition to brightness, the saturation and the dynamics. Specific embodiments of mathematical functions related to these three types of content characteristics are presented in the following.

The brightness of a region (local or global) can be measured using the average brightness or luminance of a frame. This parameter is measured in many picture quality processing chains employed by modern TV sets. In an embodiment, the brightness of a specific light source related to a subregion can be set in accordance with the general form:

brightness=k×brightness of the subregion+(1−k)×global brightness,

with k being a constant ranging from 0 to 1. The brightness of a light source for a given subregion may thus be implemented as a ‘fader’ between the brightness of the subregion and the global brightness.

In an embodiment, the color of the light sources may be modulated by the global content based on conditional criteria. For example, the data processor of the device may implement conditional statements, so that the brightness (or other content characteristics) is only modulated by the global brightness if the brightness of the subregion is larger than the global brightness. Other conditions or predefined criteria may be used.

The saturation can be measured in several ways. For example as a measure on the form of: (Max(R, G, B)−Min (R, G, B))/Max(R, G, B) or as the length of the UV vector in a YUV color space. In an embodiment, the saturation is based on a transfer function from the saturation measure of the global content property to an adjustment factor of a predefined saturation control of the one or more light sources.

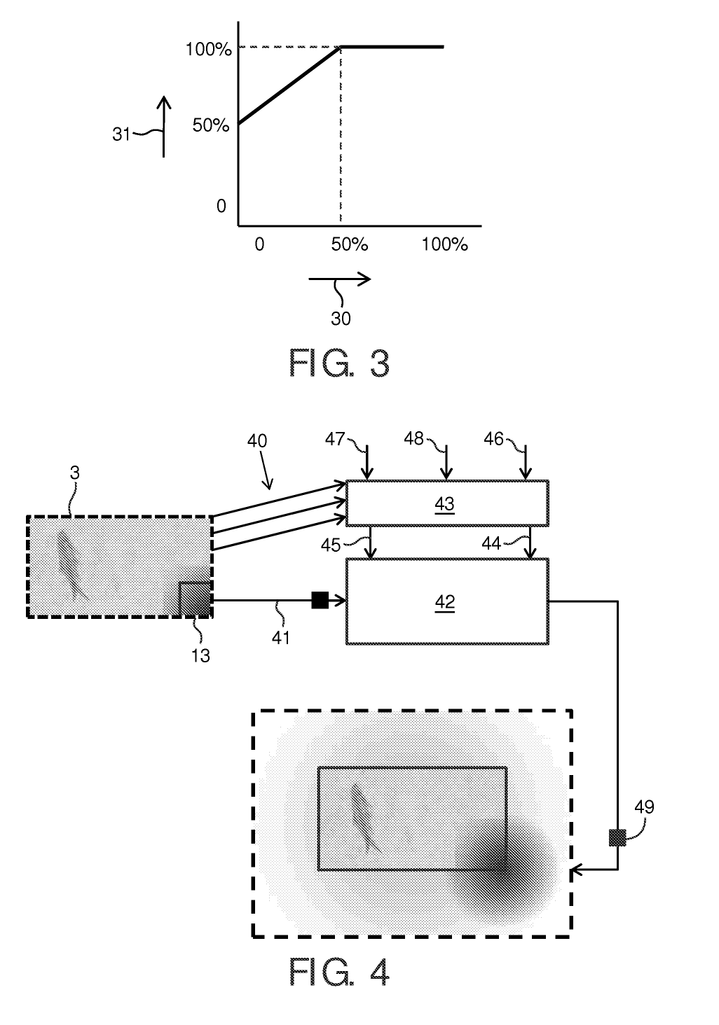

FIG. 3 schematically shows an example of a transfer function, which maps the global saturation 30 along the x-axis to a de-saturation factor 31 expressed along the y-axis. Tests have shown that non-saturated ambience lighting in a saturated scene is considered less disturbing than the other way around. This insight is reflected in the illustrated transfer function. If the global saturation is above a certain threshold, the local saturation is not adjusted (the gain is 100% meaning that the local measured color is kept) and when the global saturation drops below the threshold, the local measured color is de-saturated (the gain is <100% meaning that a saturation algorithm will de-saturate the input). In embodiments, the transfer function may typically work on top of the setting defined in the general saturation control or in user specified control. Moreover, the transfer function may also depend on a user mode, e.g. above a certain user-defined level, the graph gain is set to 100%, as well as if for example the predefined saturation control for a certain user mode is already 150% (i.e. always saturate the colors to 150%), the function defined above would fade between 50%×150%=75% saturation and 100%×150%=150%. As mentioned in connection with the brightness, conditional statements may be used to further control the light sources.

The dynamics can also be characterized in several ways. A simple metric can be the sum of the lengths of the motion vectors calculated for each block of pixels. Motion vector calculation may also be used for motion-adaptive picture quality enhancements. In other embodiments, may also or may alternatively the audio information be used as the metric. High levels of audio loudness usually are linked to exciting moments in the content. In an embodiment, the dynamics of the individual light sources may be adjusted by adjusting temporal filtering settings of the ambience lighting system. In an embodiment, the temporal filter of the general form:

output=k×current input+(1−k)×previous output.

The k factor is usually defined by the user mode. By adjusting the k factor the temporal behavior of the individual light sources can be controlled. In embodiment, the global dynamics setting may even be used to adjust the complete operational settings for each local color. For example, when the global dynamics metric shows that the current scene is very dynamic (so most likely very immersive), the user mode can automatically be adjusted towards high immersion settings. When the current scene is not dynamic at all, the user mode can automatically be adjusted towards a “relaxed” setting. In fact, a more advanced system can be defined where more global content metrics are combined, even with content meta data, to define the impression of the current scene. This impression can then be used to adjust the algorithm for each color.

FIG. 4 schematically illustrates an embodiment of general steps in the operation of an ambience lighting system in accordance with the present invention.

Content is displayed on a display screen 3. In the illustrated embodiment, the color of the background and of the illustrated object (the fish) is non-saturated. In the bottom right corner a saturated object is present. The color setting of the light source in the bottom right corner is influenced by the global color of the displayed content, resulting, among other, in a de-saturation of color of the emitted light sources associated to the red-object.

Based on the display content, the content characterizer accesses or determines global characteristics 40, e.g. the global brightness, the global saturation and the global dynamics. Moreover, the content characterizer accesses or determines the local content characteristics 41, e.g. the local brightness, the local saturation and the local dynamics. Both the local and the global characteristics are input into functional units of the controller 42, 43. In the illustrated embodiment, the controller implements two functional units, a first controller unit 42 and a second controller unit 43. The first controller may, based on predefined settings 44 and adaptive settings 45 and the local content characteristics 41 of the subregion 13, generate an output signal 49 in order to control the relevant light source. In a known system, the adaptive settings may be user settings, allowing a user to select a user mode or style of operation. In the current embodiment, the predefined settings and the adaptive settings are fed by the second controller unit 43. The predefined settings may in the illustrated embodiment be stored or accessed by the second controller. In addition, the second controller may receive user settings 47 which define a user mode or style. The settings governing the use of the global characteristics may be split between the predefined settings 46, for example implementing the algorithm used, and user-global settings 48, for example storing k-values for the algorithms. The user-settings 47, 48 and the predefined settings 46 are input into the first controller module in order to determine the output settings in order to control the light sources of the ambience system.

It is an advantage of the implementation as illustrated in this embodiment, that the functionality related to the global content characteristics may be implemented as an additional layer on top of lower layer which deals with local content characteristics, since this enables a simple update of existing systems which the functionality of embodiments of the present invention.

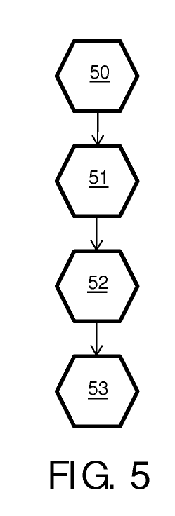

FIG. 5 schematically illustrates an embodiment of general steps in the operation of an ambience lighting system in accordance with the present invention. The ambience lighting system may e.g. be a system as disclosed in connection with FIG. 1. The method comprising:

50: associate each of the one or more light sources to subregions of the display screen;
51: determining content characteristics of the subregions of the display screen;
52: determine content characteristics of a global region of the display screen; and
53: control the color of the emitted ambience light of the one or more light sources in accordance with the determined content characteristics of the subregions and of the global region.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An ambience lighting system for use in conjunction with a display device (1) including a display screen (3), the system comprising:
one or more light sources (4-7,15-17) adapted for emitting an ambience light, the one or more light sources being disposed in a configuration so that light emitted therefrom illuminates an illumination region (8) visually appearing to a viewer, the one or more light sources each being associated to subregions (13,14) of the display screen;
a content characterizer (12) adapted for determining content characteristics of image data of the subregions of the display screen;
a controller (9) adapted to control the color of the emitted ambience light of the one or more light sources in accordance with determined content characteristics;
wherein the content characterizer is further adapted to determine content characteristics of a global region of the display screen, and wherein the controller is adapted to control the color of the emitted ambience light of the one or more light sources in accordance with the determined content characteristics of the subregions and of the global region.

2. The ambience lighting system according to claim 1, wherein the content characteristics are selected from the group consisting of: a brightness measure, a contrast measure, saturation measure, a measure related to the dynamics of content displayed on the display screen or a measure of 3D depth of the content displayed on the display screen, audio content accompanying content displayed on the display screen, or a combination of one or more thereof.

3. The ambience lighting system according to claim 1, wherein the controller (9) controls the color of the emitted ambience light of the one or more light sources based on a mathematical function which maps the determined content characteristics of the subregions and of the global region to an output content characteristic for each of the one or more light sources.

4. The ambience lighting system according to claim 1, further comprising an input unit (18) adapted for receiving input commands (2) from a user; and wherein the controller is further adapted to control the color of the emitted ambience light of the one or more light sources in accordance with the received input commands.

5. The ambience lighting system according to claim 1, wherein the subregions (13) are regions in the edge region of the display screen, and wherein a light source (16,17) is associated to a subregion to which it abuts.

6. The ambience lighting system according to claim 2, wherein the brightness measure is based on the general form: k×the brightness measure of the subregion+(1−k)×the brightness measure of the global region, with k being a constant ranging from 0 to 1.

7. The ambience lighting system according to claim 2, wherein the saturation measure is based on a transfer function from the saturation measure of the global content property to an adjustment factor of a predefined saturation control of the one or more light sources.

8. The ambience lighting system according to claim 2, wherein the measure related to the dynamics of content displayed on the display screen is based on the general form: k×current control setting of the controller+(1−k)×previous control setting of the controller, with k being a constant ranging from 0 to 1.

9. The ambience lighting system according to claim 1, wherein the control the color of the emitted ambience light of the one or more light sources in accordance with the determined content characteristics of the subregions and of the global region is based on conditional criteria.

10. The ambience lighting system according to claim 1, wherein the light sources are positioned at the periphery of the display device or the rear side of the display device, and wherein the illumination region visually appearing to the viewer to at least partly surround the display screen.

11. A controller (9) for controlling the color of emitted ambience light of an ambience lighting system to which the controller is operatively connected, the ambience lighting system comprises one or more lighting sources (4-7,15-17), the controller comprises or is communicatively connected to a
a content characterizer (12) adapted for determining content characteristics of subregions and a global region of a display screen associated to the ambience lighting system;
wherein the controller is adapted to control the color of the emitted ambience light of the one or more light sources in accordance with the determined content characteristics of the subregions and of the global region.

12. A display device (1) comprising an ambience light system as claimed in claim 1.

13. A display device (1) according to claim 8, where the display device is selected from the group of: an LCD device, a plasma device, an organic light-emitting diode (OLED) device or projection screen.

14. Method of operating an ambience lighting system used in conjunction with a display device (1) including a display screen (3), the ambience lighting system comprises:
one or more light sources (4-7,15-17) adapted for emitting an ambience light, the one or more light sources being disposed in a configuration so that light emitted therefrom illuminates an illumination region (8) visually appearing to a viewer;
the method comprising:
associate (50) each of the one or more light sources to subregions of the display screen;
determining (51) content characteristics of the subregions of the display screen;
determine (52) content characteristics of a global region of the display screen; and
control (53) the color of the emitted ambience light of the one or more light sources in accordance with the determined content characteristics of the subregions and of the global region.

15. A computer program product (19) adapted to, when running on a computing device, to perform the method steps of claim 14.
